(19) United States
(12) Patent Application Publication
(10) Pub. No.: US 2026/0285662 A1
(43) Pub. Date: Sep. 24, 2026

(54) BOOM LIFT MACHINE

(71) Applicant: J.C. Bamford Excavators Limited, Uttoxeter (GB)

(72) Inventor: Stephen Saxby, Uttoxeter (GB)

(21) Appl. No.: 19/573,201

(22) Filed: Mar. 20, 2026

(30) Foreign Application Priority Data
Mar. 21, 2025 (GB) 2504200.3

(51) Int. Cl. B66F 11/04; B66F 17/00

(52) U.S. Cl. CPC B66F 11/046; B66F 17/006

(57) ABSTRACT

A boom lift machine is provided which includes: a body; a boom defining a longitudinal axis (A-A); a mounting arrangement mounting the boom to the body; and a lifting unit extending between the boom and the mounting arrangement. The boom is pivotably connected to the mounting arrangement at or proximate a first end of the boom. The mounting arrangement is configured such that in response to actuation of the lifting unit, the boom is pivoted to raise or lower a second end thereof, and the boom is translated relative to the body. The boom lift machine also includes a counterweight mass configured to counterbalance a tipping moment of the boom lift machine. The counterweight mass is configured to translate with the boom.

### TECHNICAL FIELD

The present teachings relate to a boom lift machine, such as for example, a mobile elevating work platform or a telescopic boom lift.

### BACKGROUND

Mobile elevating work platforms and telescopic boom lifts are types of boom lift machines which comprise a boom, a first end of which is mounted to a body.

Mobile elevating work platforms have a work platform mounted to a second, opposite end of the boom.

Telescopic boom lifts may have a platform or a lifting device such as a fork or hook mounted to the second end of the boom. The boom is telescopic such that the boom can be extended and retracted along its longitudinal extent.

In boom lift machines, the boom is pivotable about a horizontal pivot axis to raise or lower the second end of the boom. In some such machines, the horizontal pivot axis is fixed on the body.

The body typically comprises a ground engaging propulsion structure (such as wheels) provided on a base. The body may include a turret mounted above the base and the turret may be a turntable which is rotatable about a vertical axis relative to the base. The boom may be mounted to the turntable so as to rotate with the turntable.

When the boom is any of extended, angled upwardly and loaded, such boom lift machines are subjected to a tipping moment, the size and direction of which varies depending on the position of the boom and the payload carried by the boom. If adequate balancing forces are not provided, such tipping moments can cause instability and, in some cases, the machine to tip over. Because of this, the reach and load achievable by a machine is limited by the tipping moments experienced and the overall mass of the machine.

The present teachings seek to provide an improved boom lift machine.

### SUMMARY

The present invention provides a boom lift machine according to the appended claims.

According to an aspect of the present teaching there is provided a boom lift machine comprising: a body; a boom defining a longitudinal axis; a mounting arrangement mounting the boom to the body; and a lifting unit extending between the boom and the mounting arrangement.

The boom may be pivotably connected to the mounting arrangement at or proximate a first end of the boom.

The mounting arrangement may be configured such that, in response to actuation of the lifting unit, the boom may be pivoted to raise or lower a second end thereof and may be translated relative to the body.

The boom lift machine may further comprise a counterweight mass (which may be referred to herein as a counterweight, weight or dynamic counterweight) configured to counterbalance a tipping moment of the boom lift machine. The counterweight mass may be configured to translate with the boom.

Advantageously, the provision of a counterweight which translates with the boom can improve the performance of a boom lift machine and may increase the out-reach (in other words, the distance of the second end of the boom from the pivot axis) achievable by the boom at one or more of a lowered, raised or intermediate position, as defined by the extent to which the boom is pivoted. The translation of the boom relative to the body may cause the counterweight to move forwards as the boom is raised and rearwards as the boom is lowered. In doing so, the center of gravity of the machine may be altered to reduce the tipping moment in the different boom positions and aid the stability of the machine.

The mounting arrangement may form part of a four bar linkage including: a first arm extending from a first pivot connected to the body to a second pivot connected to the boom; and a second arm extending from a third pivot connected to the body to a fourth pivot connected to the boom. The first pivot may be spaced from the third pivot and the second pivot may be axially spaced from the fourth pivot along the boom.

A mounting arrangement comprising these features provides a simple and effective mechanism for allowing the boom to be both pivotable to raise or lower a second end thereof, and translatable relative to the body of the boom lift machine. This may also allow the path along which the boom translates relative to the body to be adjusted by adjusting the relative positions of any of the first, second, third and fourth pivots.

The first pivot may be spaced from the third pivot in the direction of a longitudinal axis of the body. The boom may be pivotably connected to the mounting arrangement about a pivot axis. The fourth pivot may define the pivot axis. This arrangement of pivots allows the pivot axis of the boom to move along the path defined by the mounting arrangement as the boom translates.

The lifting unit may extend between the boom and the first arm. The lifting unit may be a hydraulic cylinder.

The counterweight mass may be a weight mounted to the boom at or proximate the first end thereof. The weight may have a width less than a width of the boom, and/or may be of a planar construction. The weight may be mounted to the boom so as to be pivotable. The pivot mounting of the weight may allow the orientation of the weight relative to the boom to be maintained or controlled as the boom is translated which may improve the stability and/or achievable work zone of the boom. The pivoting of the counterweight mass may be about a pivot axis about which the boom is pivotably connected to the mounting arrangement.

The weight may extend forwards of the pivot axis such that the center of gravity of the weight is forward of the pivot axis and towards the center of the machine.

Providing a forward projecting weight can help to maximize dynamic offset and stability improvements provided by the weight.

The weight may comprise a foremost edge which extends substantially parallel to the lifting unit when the boom is fully raised. The foremost edge may extend as far forward as reasonably practical. The foremost edge may be proximate the lifting unit. The foremost edge may be parallel to the longitudinal axis of the lifting unit when the boom is in an uppermost position and/or the boom is fully extended. The separation between the foremost edge and the lifting unit may be less than 100mm, preferably less than 50mm and may be at least 15mm, preferably at least 30mm.

The weight may comprise a connection portion for attaching the weight to the boom.

The connection portion may be pivotably attached to the boom by a pin which provides the pivot axis for the weight.

The boom lift machine may comprise a levelling member. The levelling member may be configured to keep a component, for example, a platform, at the second end of the boom level as the boom is raised and or lowered. The weight and the levelling member may both be pivotably attached to the boom via a common mount. The weight may be attached to the levelling member.

The boom lift machine may comprise a system configured to control the orientation of the weight as it translates with the boom, thus improving the stability of the machine and helping to reduce the tipping moment. The controlled movement may also avoid contact or impact between the weight and other component parts of the boom lift machine such as the lifting unit, thus reducing the risk of damage to the boom lift machine during use.

The system may be configured such that the weight does not rotate relative to the body and/or is maintained in a substantially vertical orientation as it translates with the boom. The system may form a further four bar linkage.

The system may comprise a tension rod, wherein a first end of the tension rod is pivotably connected to the body, and wherein a second end of the tension rod is pivotably attached to the connection portion at a tension rod pivot, wherein the tension rod pivot is spaced from the pivot axis.

This may allow the orientation of the weight to be adjusted by adjusting the space provided between the tension rod pivot and the pivot axis. The further four bar linkage may comprise the tension rod and the second arm. This may allow the orientation of the weight to be more accurately controlled as the boom is translated.

The common mount may comprise the connection portion, and a first end of the levelling member may be pivotably connected to the connection portion at a location forward of the pivot axis, and a second end of the levelling member may be pivotably connected to the boom at an axially forward position.

The levelling member may be a hydraulic cylinder connected to a hydraulic system which acts to keep a platform at the second end of the boom level as the boom is raised and or lowered.

The boom lift machine may comprise a further mass configured to counterbalance the weight of the boom, wherein the further mass may be fixed relative to the body.

The further, fixed mass can further improve the performance of a boom lift machine and may increase the out-reach achievable by the boom at one or more of a lowered, raised or intermediate position, as defined by the extent to which the boom is pivoted about the pivot axis.

The further mass may comprise a slot configured to receive the weight.

The boom may be a telescopic boom.

The body may comprise a base and a rotating structure. The rotating structure may comprise a turret, the boom, the mounting arrangement, the lifting unit and the counterweight mass. The turret may be mounted for rotation about a slew axis on the base, and the mounting arrangement may mount the boom to the turret. This allows the boom to be rotated in a horizontal direction or in other words moved to a position at an angle to the base, for example, to a non-parallel orientation relative to a longitudinal axis of the base, thus making the boom lift machine easier for operators to use.

The counterweight mass may be configured to translate from a position removed from the slew axis when the boom is lowered to a position closer to the slew axis when the boom is raised.

The position of the counterweight mass when the boom is raised may be such that the center of gravity of the rotating structure is located approximately in line with the slew axis.

According to another aspect of the present teaching there is provided a boom lift machine comprising: a body; a boom defining a longitudinal axis; a mounting arrangement mounting the boom to the body; and a lifting unit extending between the boom and the mounting arrangement, wherein the boom is pivotably connected to the mounting arrangement at or proximate a first end of the boom, wherein the mounting arrangement is configured such that in response to actuation of the lifting unit, the boom is pivoted to raise or lower a second end thereof, and the boom is translated relative to the body, the boom further comprising a counterweight mass configured to counterbalance a tipping moment of the boom lift machine.

Advantageously, this improves the performance of a boom lift machine and may increase the stable working zone achievable by the boom at one or more of a lowered, raised or intermediate position, as defined by the extent to which the boom is pivoted.

The counterweight mass may be provided in the boom, for example, at or proximate the first end thereof.

This may provide a simplified design of a boom lift machine according to the present teachings.

The boom lift machine may comprise a further mass configured to counterbalance the weight of the boom, wherein the further mass is fixed relative to the body.

The further, fixed mass can further improve the performance of a boom lift machine and may increase the out-reach achievable by the boom at one or more of a lowered, raised or intermediate position, as defined by the extent to which the boom is pivoted.

According to another aspect of the present teaching there is provided a boom lift machine comprising:

a body;

a boom defining a longitudinal axis;

a mounting arrangement mounting the boom to the body; and

a lifting unit extending between the boom and the mounting arrangement,

wherein the boom is pivotably connected to the mounting arrangement at or proximate a first end of the boom,

wherein the mounting arrangement is configured such that in response to actuation of the lifting unit, the boom is pivoted to raise or lower a second end thereof, and the boom is translated relative to the body,

the mounting arrangement further comprising a counterweight mass configured to counterbalance a tipping moment of the boom lift machine.

Advantageously, this improves the performance of a boom lift machine and may increase the out-reach (in other words, the distance of the second end of the boom from the pivot axis) achievable by the boom at one or more of a lowered, raised or intermediate position, as defined by the extent to which the boom is pivoted.

In some embodiments, the mounting arrangement may form part of a four bar linkage including:

a first arm extending from a first pivot connected to the body to a second pivot connected to the boom; and

a second arm extending from a third pivot connected to the body to a fourth pivot connected to the boom,

wherein the first pivot is spaced from the third pivot and the second pivot is axially spaced from the fourth pivot along the boom.

In some embodiments, the counterweight mass may be provided in or on the first arm and / or in or on the second arm.

The mounting arrangement comprising these features provides a simple and effective mechanism for allowing the boom to be both pivotable to raise or lower a second end thereof, and translatable relative to the body of the boom lift machine. This may also allow the path along which the boom translates relative to the body to be adjusted by adjusting the relative positions of any of the first, second, third and fourth pivots. Further, providing the counterweight mass in or on the first and / or the second arm may provide a simplified and more cost effective way of producing a boom lift machine according to the present teachings.

The mounting arrangement may be configured such that in response to actuation of the lifting unit, the boom is pivoted to raise or lower a second end thereof, wherein the counterweight mass is configured to move relative to the slew axis such that the center of gravity of the rotating structure is approximately in line with the slew axis when the second end of the boom is raised.

The skilled person will appreciate that except where mutually exclusive, a feature described in relation to any one of the aspects, embodiments or examples described herein may be applied mutatis mutandis to any other aspect, embodiment or example. Furthermore, except where mutually exclusive, any feature described herein may be applied to any aspect and/or combined with any other feature described herein.

### BRIEF DESCRIPTION OF DRAWINGS

Embodiments disclosed herein will now be described, by way of example only, with reference to the accompanying drawings, in which:

FIG. 1 is a side view of a boom lift machine with a boom in an extended, lowered position;

FIG. 2 is a side view of a boom lift machine with the boom in an extended, raised position;

FIG. 3 is a side section view of part of a boom lift machine with the boom in a lowered position;

FIG. 4 is a side section view of part of the boom lift machine of FIG. 3 with the boom raised to a mid-elevation position;

FIG. 5 is a side section view of part of the boom lift machine of FIG. 3 with the boom in a fully raised position;

FIG. 6 is an isometric view of part of the boom of the boom lift machine of FIG. 3, also showing a weight and some of the system; and

FIG. 7 is an isometric view of part of the boom of the boom lift machine of FIG. 3 showing some of a mounting arrangement.

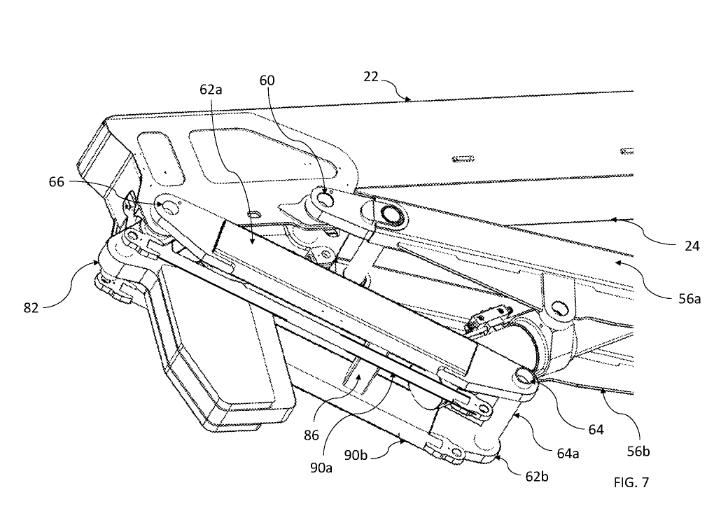

### DETAILED DESCRIPTION

In the following detailed description, numerous specific details are set forth in order to provide a thorough understanding of various embodiments and the inventive concept. However, those skilled in the art will understand that: the present invention may be practiced without these specific details or with known equivalents of these specific details; that the present invention is not limited to the described embodiments; and, that the present invention may be practiced in a variety of alternative embodiments. It will also be appreciated that well known methods, procedures, components, and systems may not have been described in detail.

References to vertical and horizontal and terms such as front, rear, lateral, side, upper and lower in the present disclosure should be understood to be in relation to the machine when stood on horizontal ground in a non-working condition. They are used for ease of understanding and should not be taken as limiting. Further approximately aligned with, approximately parallel to, approximately perpendicular to and approximately horizontal and approximately vertical may each be understood to mean within +/- 10 degrees or within +/- 5 degrees of aligned with, parallel to, perpendicular to, horizontal or vertical.

Unless otherwise defined, the term axial is generally used in relation to the longitudinal axis of the boom. The term width is generally used in relation to the longitudinal length, that is, transverse to the length.

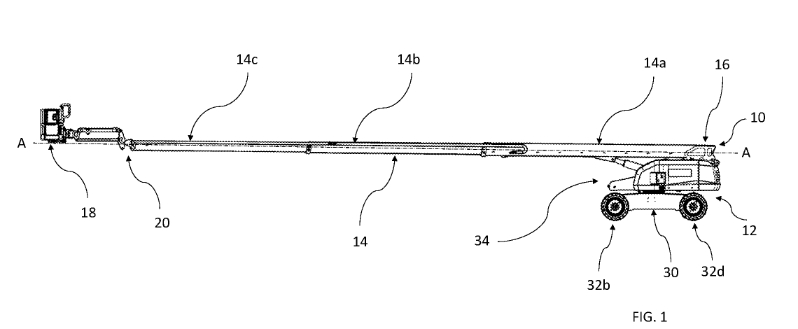

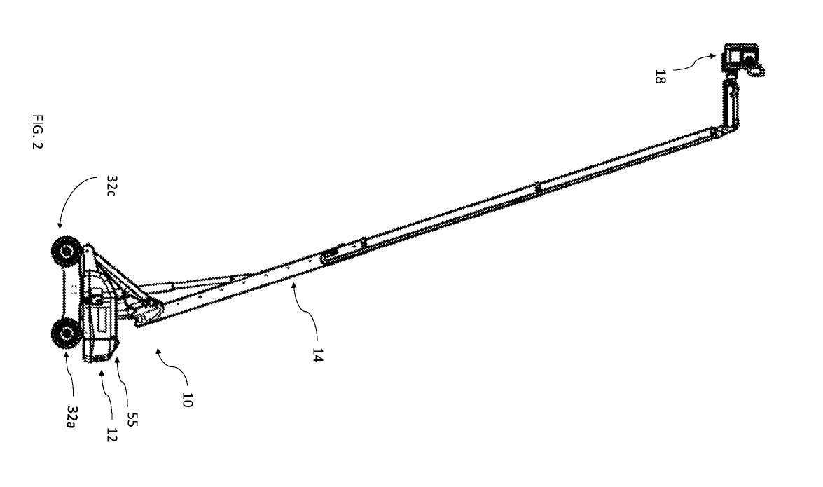

With reference to FIGS. 1 and 2, a boom lift machine 10 of the present teachings is illustrated. In the embodiment shown, the boom lift is in the form of a telescopic boom lift. In any embodiment including that shown, the boom lift machine 10 comprises a body 12 and a boom 14 mounted to the body 12 at or proximate a first end 16 of the boom 14 for movement relative to the body 12. The boom 14 extends along a longitudinal axis A-A defining a boom axial direction.

The boom 14 may be made up of a plurality of telescopic boom segments which fit one inside the other when the boom 14 is retracted and which extend consecutively in the longitudinal direction when the boom 14 is fully extended. In the embodiment shown in FIGS. 1 and 2, the boom 14 comprises three telescopic boom segments: an outer boom segment 14a; an intermediate boom segment 14b; and an inner boom segment 14c. The number of boom segments and their configuration may differ.

A drive mechanism (not shown) such as a chain mechanism or other suitable drive mechanism is configured to drive boom axial movement of the telescopic boom segments relative to each other. In the embodiment shown, the drive mechanism is configured to drive boom axial movement of the inner boom segment 14c relative to the intermediate boom segment 14b and to drive boom axial movement of the intermediate boom segment 14b relative to the outer boom segment 14a so as to extend and retract the telescopic boom 14 as required. It will be understood that in any embodiment of the invention, the boom lift machine 10 may include a single, inextensible boom rather than a telescopic boom of the sort shown in FIGS. 1 and 2.

In the embodiment shown, the boom lift machine 10 includes a working platform 18 provided at a second, opposite end 20 of the boom 14 from the first end 16 thereof. In other embodiments which are not shown, it will be understood that the boom lift machine can include another configuration, for example, a lifting device such as a hook or one or more forks, in place of the working platform 18.

In any embodiment including that shown, the body 12 of the boom lift machine 10 may comprise a ground engaging propulsion structure provided on a base. In some embodiments and as shown in FIGS. 1 and 2, the base comprises a chassis 30. The ground engaging propulsion structure may comprise a plurality of wheels although in other embodiments which are not shown it could comprise one or more tracks or other suitable propulsion structure. In the embodiment shown, the boom lift machine 10 comprises a chassis 30 on which four wheels 32a-d are provided.

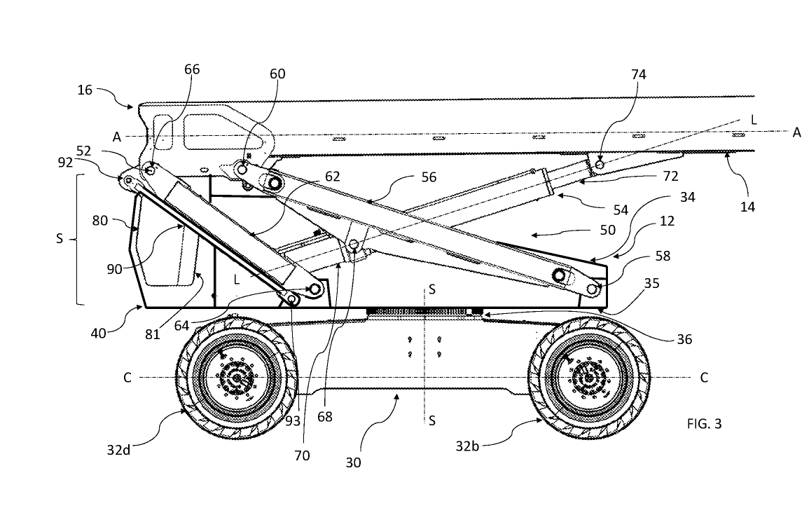

In any embodiment including that shown and as seen for example, in FIG. 3, the body 12 of the boom lift machine 10 may comprise a turret 34 which in some embodiments including that shown may be mounted to the base for rotation about a slew axis or a vertical axis S-S relative to the base or chassis 30, thus forming a rotating structure together with other components of the boom lift machine 10 which are mounted to the turret 34 for rotation therewith. In any embodiment, the turret 34 may be able to rotate through a full 360 degree rotation relative to the base or may be able to rotate through only part of a full 360 degree rotation. In any embodiment, the turret 34 may be mounted to the chassis 30 on a turntable 36 as seen for example, in FIG. 3.

As seen in FIGS. 3 to 5, in any embodiment, the boom 14 is mounted to the body 12 by a mounting arrangement 50. The boom 14 is pivotably connected to the mounting arrangement 50, for example, being connected along a pivot axis 52 at or proximate the first end 16 of the boom 14. The pivot axis 52 may extend approximately horizontally and /or may extend approximately perpendicular to the longitudinal axis A-A of the boom 14. The pivot axis 52 may extend across the full width of the boom 14.

In any embodiment, a lifting unit 54 extends between the boom 14 and the mounting arrangement 50. The lifting unit 54 may extend along an axis L-L and is configured to extend in the lifting unit axial direction, where the lifting unit axial direction is defined along the axis L-L. Extension of the lifting unit 54 causes the boom 14 to rotate about the pivot axis 52 to raise the second end 20 of the boom 14. The lifting unit 54 is further configured to retract causing the boom 14 to rotate about the pivot axis 52 to lower the second end 20 of the boom 14. In any embodiment, the lifting unit 54 may be pivotably connected to the mounting arrangement 50.

The mounting arrangement 50 may take various different forms. In the illustrated embodiment, the mounting arrangement 50 is configured such that in response to actuation (extension or retraction) of the lifting unit 54, the boom 14 is pivoted about the pivot axis 52 to raise or lower the second end thereof as described above, and the boom 14 (and therefore also the pivot axis 52) is also translated relative to the body 12. In other words, the boom 14 may be mounted to the body 12 such that, due to actuation of the lifting unit 54, it may move both horizontally and vertically in an arc relative to the body 12 as well as pivoting about the pivot axis. The mounting arrangement 50 may be at least partially surrounded by an exterior casing 55 of the body 12 or of the turret 34, as seen for example, in FIG. 2.

In order to provide the horizontal translation of the first end of the boom, the mounting arrangement 50 may form part of a four bar linkage. For example, the mounting arrangement 50 may comprise a first arm 56 extending from a first pivot 58 connected to the body 12 (the turret 34 in some embodiments and as shown in FIGS. 3 to 5) to a second pivot 60 connected to the boom 14. In any embodiment and as shown, the first pivot 58 and /or the second pivot 60 may extend approximately horizontally and /or may extend approximately perpendicular to the longitudinal axis A-A of the boom 14. The mounting arrangement 50 may further comprise a second arm 62 extending from a third pivot 64 connected to the body 12 (the turret 34 in some embodiments and as shown in FIGS. 3 to 5) to a fourth pivot 66 connected to the boom 14. In any embodiment and as shown, the third pivot 64 and /or the fourth pivot 66 may extend approximately horizontally and /or may extend approximately perpendicular to the longitudinal axis A-A of the boom 14. In any embodiment, the fourth pivot 66 may define (or in other words correspond to) the pivot axis 52 about which the boom 14 is connected to the mounting arrangement 50. In any embodiment, the first arm 56 may be located axially forward of the second arm 62.

The first pivot 58 may be spaced from and forward of the third pivot 64. In any example and as shown in FIGS. 3 to 5, the first pivot 58 may be spaced from the third pivot 64 in the direction of a longitudinal axis of the body, in some examples, the longitudinal axis C-C of the chassis 30 when the turret 34 is in its resting position. In any embodiment, the second pivot 60 may be axially spaced from and / or forward of the fourth pivot 66 along the boom, for example, along the longitudinal axis A-A of the boom 14.

As shown in FIGS. 3 to 5, the first pivot 58 may be located towards the front of the turret 34. In any embodiment and as shown in FIGS. 3 to 5, the first pivot 58 may be located towards the bottom 35 of the turret 34. In any embodiment and as shown in FIGS. 3 to 5, the second pivot 60 may be higher than the first pivot 58 in any position of the boom 14.

As shown in FIGS. 3 to 5, the third pivot 64 may be located towards the rear of the turret 34. In any embodiment and as shown in FIGS. 3 to 5, the third pivot 64 may be located towards the bottom 35 of the turret 34. In any embodiment and as shown in FIGS. 3 to 5, the fourth pivot 66 may be higher than the third pivot 64 in any position of the boom 14.

It will be understood that in any embodiment, the first and second arms 56, 62 may form a main four bar linkage together with the turret 34 and the boom 14. The main four bar linkage acts to define the trajectory of movement of the pivot axis 52 on the boom 14 under the action of the lifting unit 54. It will be understood therefore that by varying the relative dimensions and locations of the components of the main four bar linkage, the trajectory of movement of the pivot axis 52 can be designed to take a desired path.

As shown in FIGS. 3 to 5, in some embodiments the lifting unit 54 is pivotably attached to the first arm 56 at a lifting unit connector 68. The lifting unit 54 may also be pivotably attached to the boom 14 by a lifting unit attachment 74. The lifting unit 54 may be attached to the boom 14 at a location axially forward of the second pivot 60 and / or axially forward of the connection between the first arm 56 and the lifting unit 54. The lifting unit 54 could take any desired form, for example, being an electromechanical linear actuator. Advantageously however, the lifting unit 54 may comprise a hydraulic cylinder.

The hydraulic cylinder may comprise a housing 70 and a piston rod 72. The piston rod 72 may be axially moveable along the lifting unit axis L-L relative to the housing 70. In any embodiment, the housing 70 or the piston rod 72 may be pivotably attached to the first arm 56 at the lifting unit connector 68. The other of the housing 70 or the piston rod 72 may be attached to the boom 14. The first arm 56 may be a cylinder support arm. In any embodiment, the lifting unit connector 68 may be provided at a location removed from both the first pivot 58 and the second pivot 60. In any embodiment, the lifting unit connector 68 may be provided at a location approximately midway between the first pivot 58 and the second pivot 60. In some examples, approximately midway between the first pivot 58 and the second pivot 60 may mean at least one quarter of the full distance between the first pivot 58 and the second pivot 60 from either the first pivot 58 or the second pivot 60.

The boom lift machine 10 may further comprise a counterweight mass which is configured to translate with the boom 14 and to counterbalance the weight of the boom 14. The translatable counterweight mass may be referred to as a dynamic counterweight mass in contrast to a conventional static counterweight which is fixed in relation to the turret.

The counterweight mass can take any suitable form which allows it to be translated with the boom as the boom is raised or lowered. In some embodiments, the counterweight mass could, for example, be provided in the boom 14 by providing additional non-structural material in the boom 14 proximate the first end 16 thereof or by making a portion of the boom solid. Additionally or alternatively, the counterweight mass could be provided in the mounting arrangement 50, for example, by providing additional non-structural material into the mounting arrangement 50, such as in the first and / or the second arms 56, 62. In addition to or as an alternative to the above, the counterweight mass may be a weight 80 attached to the boom 14 proximate the first end 16 thereof.

The attachment of the boom may be by any suitable method which allows the weight to be translated fore and aft with the boom to move the center of gravity towards the center of the machine as the boom is raised, and rearwards towards the outer periphery of the turret when lowered.

The weight may be attached to the boom via a pin attachment. The pin attachment may pass through the counterweight and an attachment point on the boom and may, in some embodiments, allow the weight to be pivoted as the boom translates. In the illustrated embodiment, weight 80 is attached to the boom 14 at the pivot axis 52 and is pivotable about the pivot axis 52.

The weight 80 may extend downwardly from the pivot axis 52 to fit within a space S underneath the boom 14 when the boom 14 is in the lowered position. The space S may be further defined as being between the boom 14 and the base 35 of the turret 34 when the boom 14 is in the lowered position.

The weight 80 may have a width less than the width of the boom 14 and may be of a planar construction. In the illustrated embodiment, the weight 80 may be formed by casting as a single unitary mass, but may be formed from multiple joined metal plates, by forging as a single unitary mass, by additive manufacturing, e.g., 3D printing, or by subtractive manufacturing, such as billet machining.

The shape of the weight may be any suitable shape which allows the center of gravity of the machine to be moved in a desired way as the boom is raised. In the illustrated embodiment, the weight comprises a plate-like (e.g., planar) construction having a rear edge, a forward edge, an upper edge and a lower edge. The attachment point of the weight, e.g., the pivot axis 52, is provided above the upper edge and towards the rear edge so as to be rearward of the geometric center and center of gravity of the weight itself. The rear edge may be shaped to broadly correspond to the external shape of the turret to maximize the volume occupied by the weight without breaching or otherwise causing the rear line of the turret to be affected. The rear edge is located inboard of the external surface of the turret so as to be largely concealed therein.

In the illustrated embodiment, the foremost edge of the weight may be located substantially forward of the rearmost edge and pivot axis, along the axis A-A, to aid with the movement of the center of mass of the machine when the boom is in an elevated position.

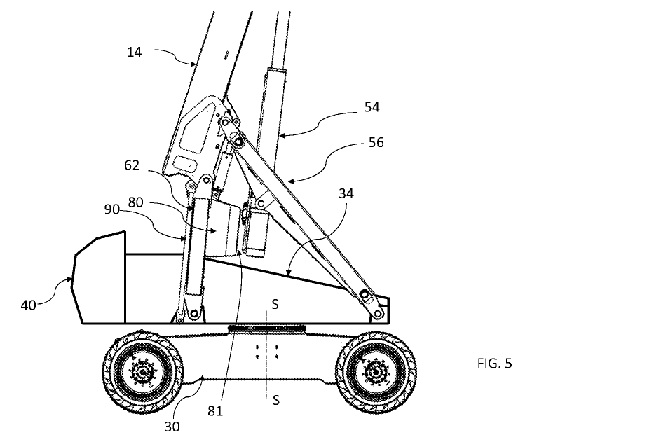

The forward position of the foremost edge 81 may be as far over towards the slew axis as possible. In the illustrated embodiment, the foremost edge is located proximate the lifting unit and extends substantially parallel to the lifting unit 54 when the boom 14 is fully raised (as seen for example, in FIG. 5) whilst providing a suitably large and uniform separation between the outer housing of the lifting unit and foremost edge. The size of the separation may be suitable to prevent accidental contact in use and/or to avoid any trapping issues for hydraulic hoses or the like. In the illustrated embodiment, the separation is around 50mm, but this may be vary in other embodiments.

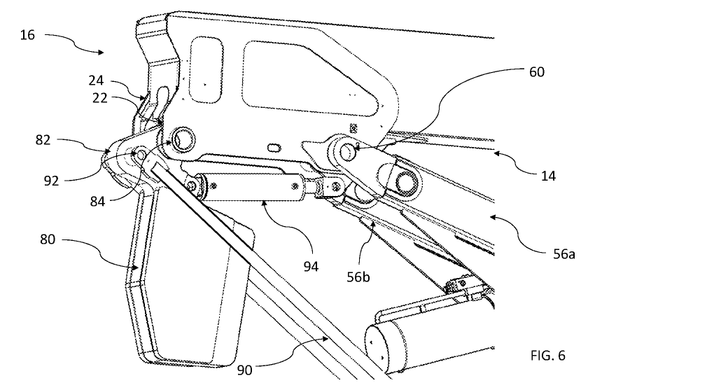

As shown in greater detail in FIG. 6, the weight 80 may include a connection portion 82 for attaching the weight 80 to the boom 14. The connection portion 82 may be integrally formed with the weight 80 or, in other embodiments (not shown) may be connected to the weight 80 by any suitable connection means including but not limited to a pin extending through respective apertures in the connection portion and the weight. The connection portion 82 and the weight 80 may be integrally formed from a single metal cast.

The connection portion 82 may be pivotably attached to the boom 14 by a pin (not shown) which extends through an aperture 84 in the boom 14 and a corresponding aperture (not shown) in the connection portion 82.

The boom 14 may be largely conventional and comprises a hollow section having spaced apart side walls 22, 24 such that the pin (not shown) can extend across the width of the boom 14 from a first sidewall 22 thereof to a second, opposite sidewall 24 thereof. The mounting arrangement 50 (including the first arm 56 and the second arm 62 in the embodiment shown in FIGS. 3 to 6) is connected to at least one sidewall of the boom 14. The first arm 56 may comprise two first arm portions 56a, 56b which are fixed parallel to and spaced from each other so as to extend outside the respective first and second sidewalls 22, 24 of the boom 14. The first arm portions 56a, 56b are fixed parallel to and spaced from each other by the first pivot 58 and the second pivot 60. The first pivot 58 and the second pivot 60 may comprise respective pins (not shown) extending through respective apertures in the first arm portions 56a, 56b. The first arm portions 56a, 56b may also be fixed parallel to and spaced from each other by one or more fixings (not shown) extending between the first arm portions 56a, 56b.

The second arm 62 (which is omitted from FIG. 6 for clarity) may comprise two second arm portions 62a, 62b which are fixed parallel to and spaced from each other so as to extend outside the respective first and second sidewalls 22, 24 of the boom 14. The second arm portions 62a, 62b are fixed parallel to and spaced from each other by the third pivot 64 and the fourth pivot 66. The third pivot 64 and the fourth pivot 66 may comprise respective pins (64a, not shown) extending through respective apertures in the second arm portions 62a, 62b. The second arm portions 62a, 62b may also be fixed parallel to and spaced from each other by one or more fixings 86 extending between the second arm portions 62a, 62b.

The connection portion 82 in some embodiments and as shown, is formed from a metal plate and may be roughly triangular in shape. The connection portion 82 may extend between the first sidewall 22 and the second sidewall 24 of the boom 14. In other words, at least part of the connection portion 82 may be located within the boom 14.

As shown in FIGS. 3 to 5, the boom lift machine 10 may further comprise a system for controlling the orientation of the weight 80 as it translates with the boom 14. In doing so, the movement of the weight remains predicable and controlled and allows the vertical height of the weight to be kept as low as possible as the boom moves forwards.

In order to maintain the orientation of the weight, the system may comprise a further four bar linkage. As seen more clearly in FIG. 6, the system may include a tension rod 90 pivotably connected at a first end thereof to the turret 34 and at a second end thereof to the connection portion 82 at a tension rod pivot 92 which is spaced from the pivot axis 52.

The tension rod 90 may extend approximately parallel to the second arm 62, the tension rod 90 connection 93 to the body 12 being positioned towards the rear of the body 12 relative to the third pivot 64 and the tension rod pivot 92 being positioned towards the rear of the body 12 relative to the fourth pivot 66. In some embodiments in which the connection portion 82 is roughly triangular, the pivot axis 52 may be located proximate a first corner of the connection portion 82 and the tension rod pivot 92 may be located proximate a second corner of the connection portion 82.

The tension rod 90 may comprise two tension rod portions 90a, 90b, which are fixed parallel to and spaced from each other so as to extend outside the respective first and second sidewalls 22, 24 of the boom 14. The tension rod portions 90a, 90b are fixed parallel to and spaced from each other. In any embodiment, the connection 93 and the tension rod pivot 92 may comprise respective pins (not shown) extending through respective apertures in the tension rod portions 90a, 90b.

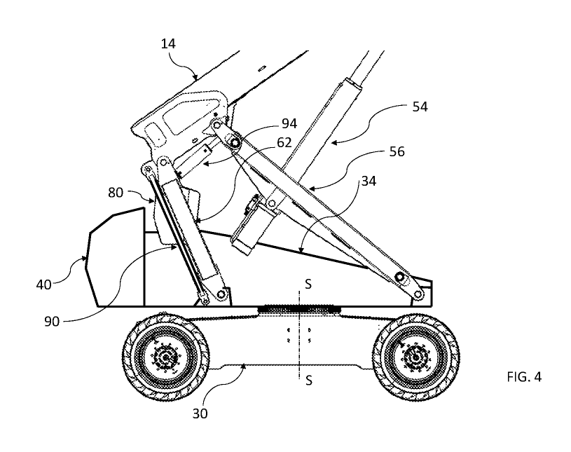

As shown in FIGS. 4 and 5, the machine may comprise a levelling member 94 which acts in unison with a basket cylinder to maintain the basket in the same orientation relative to ground as the boom is lifted. The levelling member comprises a hydraulic cylinder which is actuated by the movement of the boom when the boom is raised or lowered. Actuating the levelling member displaces an amount of hydraulic fluid which is proportional to the degree of movement in the boom. The amount of displaced hydraulic fluid provided to the lift cylinder of the platform is sufficient through the sizing of the levelling unit, to ensure that the lift cylinder of the platform is actuated by the correct amount to automatically level the basket, as well understood in the art.

In the present disclosure, the levelling unit may be attached to the weight as a matter of convenience and efficient packaging. This is possible due to the orientation of the weight remaining fixed as the boom translates.

More specifically, in the illustrated embodiment, a first end of the levelling unit is pivotably connected to the connection portion 82 at a location forward of the pivot axis 52 and a second end of the levelling unit is pivotably connected to the boom 14 at an axially forward position along the boom axis. In embodiments in which the connection portion 82 is roughly triangular, and as shown in FIG. 6, the first end of the levelling member 94 may be connected to the connection portion 82 at a third corner of the connection portion 82. As described above, the levelling member 94 may be a hydraulic cylinder which is hydraulically connected to the platform lift cylinder to keep the platform 18 level as the boom 14 is raised and or lowered.

The tension rod 90 and the second arm 62 may act together to determine the orientation or rotation of the weight 80. At least in some embodiments, the system may be configured such that the weight 80 does not rotate and / or is maintained in a substantially vertical orientation as the boom 14 and the weight 80 move under the action of the lifting unit 54. In other embodiments, the relative positions of the connection between the boom 14 and the connection portion 82 and the connection between the tension rod 90 and the connection portion 82 may be varied to change the orientation of the weight 80 as desired. By controlling the orientation of the weight 80 as it moves with the pivot axis 52, it is possible to reduce or avoid potential damage to parts of the boom lift machine 10 due to contact with the weight 80.

It will be understood that using a boom lift machine 10 of the type described above, the weight 80 may move upwardly and forwardly with the pivot axis 52 as the lifting unit 54 acts to translate the boom 14. As seen in FIGS. 3 to 5, this has the advantage that the weight 80 is positioned at the rear of the body 12 (and spaced from the slew axis S-S in an approximately horizontal direction) when the boom 14 is in the lowered extended position, thus acting against the tipping moment caused by the boom 14 extending forwardly thereof. As the second end 18 of the boom 14 moves upwardly and inwardly, the weight 80 also moves forwardly from the rear of the body 12 (towards the slew axis) such that the weight 80 is approximately located below the first end 16 of the boom 14 throughout its movement and both at the intermediate position shown in FIG. 4 and when the boom 14 is in its fully raised and extended position as shown in FIG. 5. Thus, when the boom 14 is in its fully raised and extended position, the weight 80 may be located aligned with or close to the slew axis S-S in the horizontal direction. Alternatively or additionally, the weight 80 may be located such that the center of gravity of the rotating structure including the boom and the turret is located approximately in line with the slew axis. It will be understood that this provides improved stability to the boom lift machine.

The boom lift machine 10 may comprise a fixed counterweight 40, as seen in FIGS. 3 to 5. The fixed counterweight 40 comprises a further mass, the size of which is determined based on the size and loading of the boom lift machine 10 on which it is provided. The fixed counterweight 40 may be positioned on or within the turret 34 so as to provide a stabilizing moment for acting against the moment created by a load carried by the platform 18 when the boom 14 is in the extended and lowered position as shown in FIG. 1. In any embodiment, the turret 34 may be in its resting position relative to the chassis 30 when the longitudinal axis A-A of the boom 14 is aligned with or approximately aligned with the longitudinal axis C-C of the chassis 30. The fixed counterweight 40 may be positioned such that it is located at the rear of the turret 34, at least partially behind the rear wheels 32d, 32c of the boom lift machine 10 when the turret 34 is in its resting position.

The fixed counterweight 40 may include a slot (not shown) configured to receive the weight 80 which forms the counterweight mass. Thus, when the turret 34 is in its resting position and the boom 14 is in the lowered position, the weight 80 may be located within the fixed counterweight 40. The fixed counterweight 40 may form at least part of the turret 34.

In any embodiment, proximate to the first end of the boom may be understood to mean closer to the first end 16 of the boom 14 than to the second end 20 thereof. In any embodiment, proximate the first end 16 of the boom 14 may be understood to mean positioned between the first end 16 of the boom 14 and the connection. In any embodiment, forward of may be understood to mean in the direction towards the second end of the boom 14 of the longitudinal axis of the boom 14 when the turret 34 is in its resting position and the boom 14 is in the lowered position.

The one or more embodiments are described above by way of example only and it will be appreciated that the variations are possible without departing from the scope of protection afforded by the appended claims.

1. A boom lift machine comprising:
a body;
a boom defining a longitudinal axis;
a mounting arrangement mounting the boom to the body; and
a lifting unit extending between the boom and the mounting arrangement,
wherein the boom is pivotably connected to the mounting arrangement at or proximate a first end of the boom,
wherein the mounting arrangement is configured such that in response to actuation of the lifting unit, the boom is pivoted to raise or lower a second end thereof, and the boom is translated relative to the body,
the boom lift machine further comprising a counterweight mass configured to counterbalance a tipping moment of the boom lift machine,
wherein the counterweight mass is configured to translate with the boom,
wherein the mounting arrangement forms part of a four bar linkage including:
a first arm extending from a first pivot connected to the body to a second pivot connected to the boom; and
a second arm extending from a third pivot connected to the body to a fourth pivot connected to the boom,
wherein the first pivot is spaced from the third pivot and the second pivot is axially spaced from the fourth pivot along the boom,
wherein the first pivot is spaced from the third pivot in the direction of a longitudinal axis of the body, and
wherein the counterweight mass comprises a weight mounted to the boom at or proximate the first end thereof and pivotable about a pivot axis about which the boom is pivotably connected to the mounting arrangement.

2. A boom lift machine as claimed in claim 1, wherein the fourth pivot defines the pivot axis.

3. A boom lift machine as claimed in claim 1, the lifting unit extending between the boom and the first arm.

4. A boom lift machine as claimed in claim 1, wherein the weight has a width less than a width of the boom, and / or wherein the weight is of a planar construction.

5. A boom lift machine as claimed in claim 4, wherein the weight extends forwards of the pivot axis.

6. A boom lift machine as claimed in claim 1, wherein the weight comprises a foremost edge which extends substantially parallel to the lifting unit when the boom is fully raised,

7. A boom lift machine as claimed in claim 6, wherein the foremost edge is separated from the lifting unit by less than 100mm, preferably less than 50mm.

8. A boom lift machine as claimed in claim 1, comprising a levelling member comprising a hydraulic cylinder connected to a hydraulic system which acts to keep a platform at the second end of the boom level as the boom is raised or lowered, wherein the weight and the levelling member are both pivotably attached to the boom via a common mount; and / or the weight is attached to the levelling member.

9. A boom lift machine as claimed in claim 1, comprising a further four bar linkage system configured to control the orientation of the weight as it translates with the boom.

10. A boom lift machine as claimed in claim 8, wherein the further four bar linkage system maintains the position of the weight relative to vertical as it translates with the boom.

11. A boom lift machine as claimed in claim 10, wherein the weight is maintained in a substantially vertical orientation as it translates with the boom.

12. A boom lift machine as claimed in claim 8, wherein the further four bar linkage system comprising a tension rod,
wherein a first end of the tension rod is pivotably connected to the body, and
wherein a second end of the tension rod is pivotably attached to a connection portion of the weight at a tension rod pivot, wherein the tension rod pivot is spaced from the pivot axis.

13. A boom lift machine as claimed in claim 8,
wherein the further four bar linkage system comprising a tension rod,
wherein a first end of the tension rod is pivotably connected to the body, and
wherein a second end of the tension rod is pivotably attached to a connection portion of the weight at a tension rod pivot, wherein the tension rod pivot is spaced from the pivot axis, wherein the common mount comprises the connection portion, and
wherein a first end of the levelling member is pivotably connected to the connection portion at a location forward of the pivot axis, and
wherein a second end of the levelling member is pivotably connected to the boom at an axially forward position.

14. A boom lift machine as claimed in claim 1, comprising a further mass configured to counterbalance the weight of the boom, wherein the further mass is fixed relative to the body.

15. A boom lift machine as claimed in claim 14, wherein the further mass comprises a slot configured to receive the weight.

16. A boom lift machine as claimed in claim 1, wherein the body comprises a base and a rotating structure,
wherein the rotating structure comprises a turret, the boom, the mounting arrangement, the lifting unit and the counterweight mass,
wherein the turret is mounted for rotation about a slew axis on the base, wherein the mounting arrangement mounts the boom to the turret and the boom is telescopic and optionally, the counterweight mass is configured to translate from a position removed from the slew axis when the boom is lowered to a position closer to the slew axis when the boom is raised.

17. A boom lift machine as claimed in claim 16, wherein the position of the counterweight mass when the boom is raised is such that the center of gravity of the rotating structure is located approximately in line with the slew axis.
